(19) United States
(12) Patent Application Publication
(10) Pub. No.: US 2024/0401770 A1
(43) Pub. Date: Dec. 5, 2024

(54) ILLUMINATING DEVICE

(71) Applicant: GUANGZHOU LUXVISIONS INNOVATION TECHNOLOGY LIMITED, GUANGZHOU (CN)

(72) Inventors: Yi-Wei Liu, Guangzhou (CN); Yi-Chih Lai, Guangzhou (CN)

(73) Assignee: GUANGZHOU LUXVISIONS INNOVATION TECHNOLOGY LIMITED, GUANGZHOU (CN)

(21) Appl. No.: 18/402,746

(22) Filed: Jan. 3, 2024

(30) Foreign Application Priority Data
Jun. 2, 2023 (CN) 202310649534.6

(51) Int. Cl. F21V 5/00; F21V 5/04

(52) U.S. Cl. CPC F21V 5/002; F21V 5/007; F21V 5/045; F21Y 2105/10; F21Y 2113/10; F21Y 2115/10

(57) ABSTRACT

An illuminating device including a light-emitting element array and a plurality of light-diffusing elements is provided. The light-emitting element array includes a plurality of discrete light-emitting areas. The plurality of light-diffusing elements respectively correspond to the light-emitting areas, and each light-diffusing element includes a light-entering surface and a light-exiting surface. The light beams emitted by the light-emitting areas respectively enter the corresponding light-diffusing element via the corresponding light-entering surface. After the light beams respectively leave the corresponding light-diffusing element via the corresponding light-exiting surface, the light beams respectively form a plurality of illumination beams. The illumination beams appear in an array form for illumination.

### CROSS-REFERENCE TO RELATED APPLICATION

This application claims the priority benefit of China application serial no. 202310649534.6, filed on Jun. 2, 2023. The entirety of the above-mentioned patent application is hereby incorporated by reference herein and made a part of this specification.

### BACKGROUND

### Technical Field

The present invention relates to optical devices, and in particular to an illuminating device.

### Description of Related Art

With the popularity of the portable electronic device, the requirements for the specification of the flashlight, used as one component of the portable electronic device, have also increased. How to provide optimal light output of the flashlight for the surroundings is an urgent issue that needs to be solved.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The present invention provides an illuminating device that provides regions of illumination in an array form with adjustable effects of illumination. The uniformity of the illumination light and the efficiency of heat dissipation of the light-emitting elements are also taken into account.

According to an embodiment of the present invention, an illuminating device including a light-emitting element array and a plurality of light-diffusing elements is provided. The light-emitting element array includes a plurality of discrete light-emitting areas. The plurality of light-diffusing elements respectively correspond to multiple light-emitting areas, and each light-diffusing element includes a light-entering surface and a light-exiting surface, wherein multiple light beams emitted by the multiple light-emitting areas respectively enter the corresponding light-diffusing element through the corresponding light-entering surface. The light beams respectively form a plurality of illumination beams after leaving the corresponding light-diffusing element via the corresponding light-exiting surface. The plurality of illumination beams appear for illumination in an array form.

Based on the above, in the embodiment of the present invention, the multiple light-emitting elements and the corresponding light-diffusing elements are used to generate the regions of illumination in an array form. The relative illumination intensity and color temperature of different sub-regions are adjustable, and hence the effect of illumination of the whole target region is adjustable. Further, the light-diffusing elements are used to achieve homogeneousness of illumination light, and the efficiency of heat dissipation of each light-emitting elements is high.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A shows a schematic diagram of a light-emitting element array according to an embodiment of the present invention.

FIG. 1B and FIG. 1C are schematic diagrams of illuminating devices according to embodiments of the present invention.

FIG. 2A is a 3-D schematic diagram of a partial portion of an illuminating device according to an embodiment of the present invention.

FIG. 2B is a partial plan view of the illuminating device of FIG. 2A.

FIG. 3 shows a schematic diagram of an illuminating device according to an embodiment of the present invention.

FIG. 4A is a schematic diagram of illumination of an illuminating system according to a comparative example.

FIG. 4B is a schematic diagram of illumination of an illuminating system according to an embodiment of the present invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

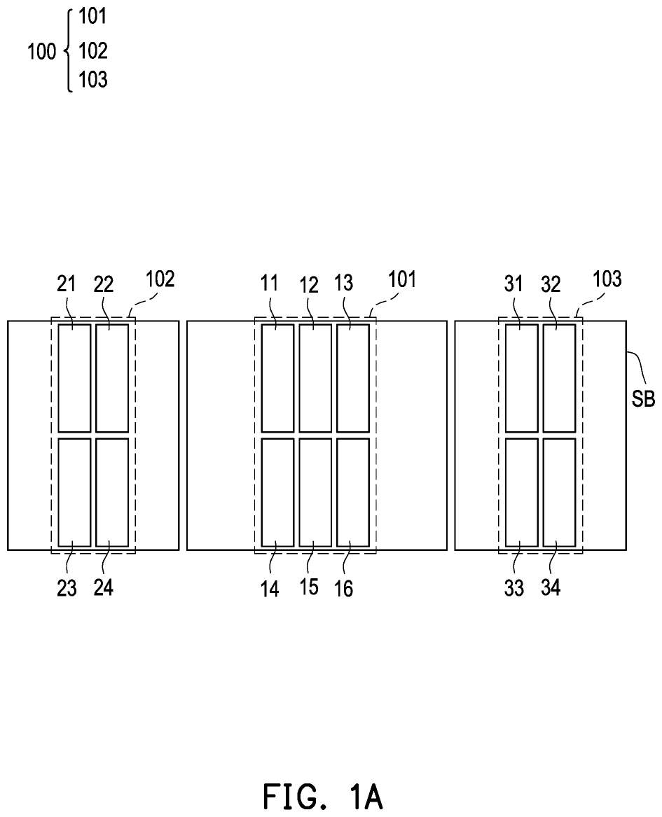

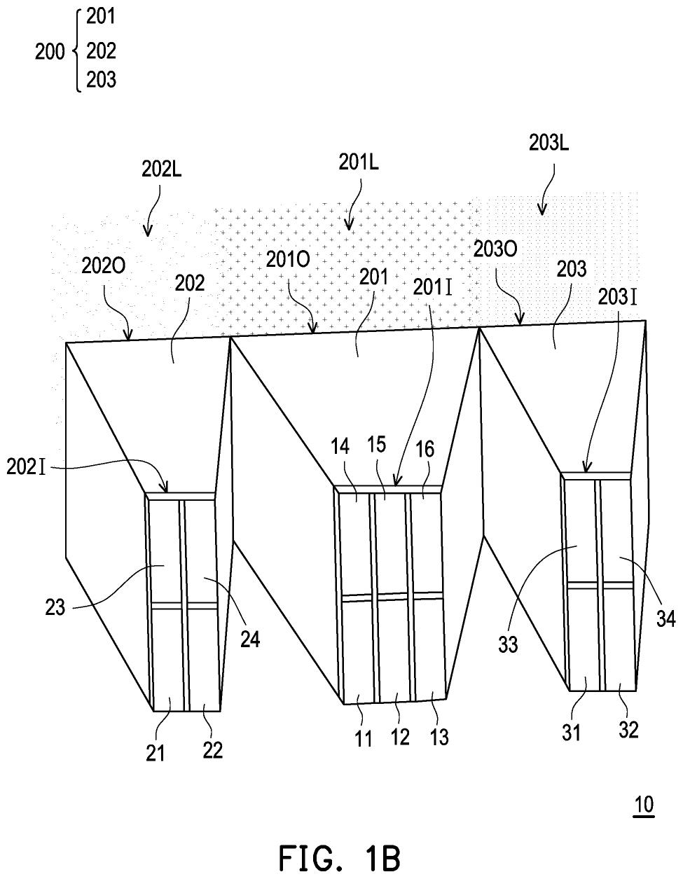

Referring to FIG. 1A to FIG. 1C, FIG. 1A shows a schematic diagram of a light-emitting element array according to an embodiment of the present invention. FIG. 1B and FIG. 1C are schematic diagrams of an illuminating device according to an embodiment of the present invention.

The illuminating device 10 includes a light-emitting element array 100 and a light-diffusing structure 200. The light-diffusing structure 200 includes a plurality of light-diffusing elements 201, 202, and 203. The light-emitting element array 100 includes a plurality of discrete light-emitting areas 101, 102, and 103, wherein the light-emitting area 101 includes light-emitting elements 11, 12, 13, 14, 15, and 16, the light-emitting area 102 includes light-emitting elements 21, 22, 23, and 24, and the light-emitting area 103 includes light-emitting elements 31, 32, 33, and 34. The above-mentioned light-emitting elements 11, 12, 13, 14, 15, 16, 21, 22, 23, 24, 31, 32, 33, and 34 are all disposed on the substrate SB.

For the convenience of understanding, the substrate SB is not shown in FIG. 1B. The light-diffusing structure 200 and the substrate SB are respectively located on opposite sides of the light-emitting element array 100. The luminous intensity of each of the light-emitting elements 11, 12, 13, 14, 15, 16, 21, 22, 23, 24, 31, 32, 33, 34 in the light-emitting element array 100 is independently controlled via the substrate SB.

The light-diffusing structure 200 is located in the direction along which each of the light-emitting elements 11, 12, 13, 14, 15, 16, 21, 22, 23, 24, 31, 32, 33, 34 in the light-emitting element array 100 emits light. The light-diffusing element 201 corresponds to the light-emitting area 101, the light-diffusing element 202 corresponds to the light-emitting area 102, and the light-diffusing element 203 corresponds to the light-emitting area 103. Specifically, the light-diffusing element 201 includes a light-entering surface 201I and a light-exiting surface 201O. Light emitted by the light-emitting area 101 enters the light-diffusing element 201 via the light-entering surface 201I, leaves the light-diffusing element 201 via the light-exiting surface 201O, and then forms the illumination beam 201L. The light-diffusing element 202 includes a light-entering surface 202I and a light-exiting surface 202O. Light emitted by the light-emitting area 102 enters the light-diffusing element 202 via the light-entering surface 202I, leaves the light-diffusing element 202 via the light-exiting surface 202O, and then forms the illumination beam 202L. The light-diffusing element 203 includes a light-entering surface 203I and a light-exiting surface 203O. Light emitted by the light-emitting area 103 enters the light-diffusing element 203 via the light-entering surface 203I, leaves the light-diffusing element 203 via the light-exiting surface 203O, and then forms the illumination beam 203L. The illumination beams 201L, 202L, and 203L appear in an array form, as shown in FIG. 1C.

It should be noted that the light-diffusing elements 201, 202, and 203 according to embodiments of the present invention are not limited to the straight-line configuration shown in FIG. 1C. In other embodiments, the illuminating device includes multiple light-diffusing elements appearing in an array form, and the number of the light-diffusing elements is multiple and not limited to three.

In this embodiment, no element is disposed between the light-emitting elements 11, 12, 13, 14, 15, 16 and the light-entering surface 201I, no element is disposed between the light-emitting elements 21, 22, 23, 24 and the light-entering surface 202I, and no element is disposed between the light-emitting elements 31, 32, 33, and 34 and the light-entering surface 203I. Since each of the above-mentioned light-emitting elements is close to the corresponding light-entering surface, light of large incident angles may be received by the light-diffusing structure 200. In some embodiments, the light-emitting elements 11, 12, 13, 14, 15, and 16 are in direct contact with the light-entering surface 201I, the light-emitting elements 21, 22, 23, and 24 are in direct contact with the light-entering surface 202I, and the light-emitting elements 31, 32, 33 and 34 are in direct contact with the light-entering surface 203I. Accordingly, light of larger incident angles may also be received by the light-diffusing structure 200.

It should be noted that height h of each light-diffusing element 201, 202, and 203 in a direction, along which light travels, is greater than the width of each light-entering surface 201I, 202I, and 203I, so that light can be fully homogenized in each light-diffusing element 201, 202, 203 before leaving each light-diffusing element 201, 202, 203. Further, the light-diffusing elements 201, 202, 203 have a function of light guiding.

It should also be noted that each of the light-diffusing elements 201, 202, and 203 in the present embodiment has a trapezoidal-pillar shape as shown in FIG. 1B and FIG. 1C. For each of the light-diffusing elements 201, 202, and 203, area of each of the light-exiting surfaces 201O, 202O, and 203O is larger than area of the corresponding one among the light-entering surfaces 201I, 202I, and 203I. For example, a ratio of length between the light-exiting surface 201O and the light-entering surface 201I is greater than 1, and a ratio of width between the light-exiting surface 201O and the light-entering surface 201I is greater than 1. A ratio of length between the light-exiting surface 202O and the light-entering surface 202I is greater than 1, and a ratio of width between the light-exiting surface 202O and the light-entering surface 202I is greater than 1. A ratio of length between the light-exiting surface 203O and the light-entering surface 203I is greater than 1, and a ratio of width between the light-exiting surface 203O and the light-entering surface 203I is greater than 1. In this case, the light-entering surfaces 201I, 202I, and 203I can be spatially spaced apart. Accordingly, the light-emitting areas 101, 102, and 103 corresponding to the light-entering surfaces 201I, 202I, and 203I can also be spatially spaced apart, which improves the efficiency of heat dissipation of the light-emitting elements 11, 12, 13, 14, 15, 16, 21, 22, 23, 24, 31, 32, 33, 34 in the light-emitting areas 101, 102, 103 so as to prevent an overheating problem from occurring in the illuminating device 10.

In some embodiments of the present invention, the illuminating device 10 is implemented as a flashlight of a portable electronic device, and each of the light-emitting elements 11, 12, 13, 14, 15, 16, 21, 22, 23, 24, 31, 32, 33, 34 in the light-emitting element array 100 is implemented as a sub-millimeter light-emitting diodes, each sub-millimeter light-emitting diode 11, 12, 13, 14, 15, 16, 21, 22, 23, 24, 31, 32, 33, 34 may emit white light of different color temperatures, and the luminous intensity thereof is independently controlled. The light-diffusing structure 200 may include glass or plastic. In some embodiment, the light-diffusing structure 200 may be manufactured in a plastic injection molding process, and hence be easily manufactured, light and low cost. The light-diffusing elements 201, 202, and 203 of the light-diffusing structure 200 can be provided separately or integrally formed. In some embodiments, the illuminating device 10 may further include one or more lens elements (not shown) disposed on the light-exiting side of the light-diffusing structure 200 so as to optimize the illumination beams 201L, 202L, and 203L coming from the light-exiting surfaces 201O, 202O and 203O.

In some embodiments, the illuminating device 10 may be a handheld flashlight, and each of the light-emitting elements 11, 12, 13, 14, 15, 16, 21, 22, 23, 24, 31, 32, 33, 34 in the light-emitting element array 100 is implemented as a light-emitting diode. The light-diffusing structure 200 may include plastic, be manufactured in a plastic injection molding process, and hence be easily manufactured, light and low cost.

In order to fully illustrate various implementation aspects of the disclosure, other embodiments of the disclosure will be described below. It should be noted here that the following embodiments follow the numeral references and part of the content of the foregoing embodiments, where the same numeral references are used to represent the same or similar elements, and descriptions of the same technical content are omitted. For descriptions of omitted parts, reference may be made to the foregoing embodiments and will not be repeated in the following embodiments.

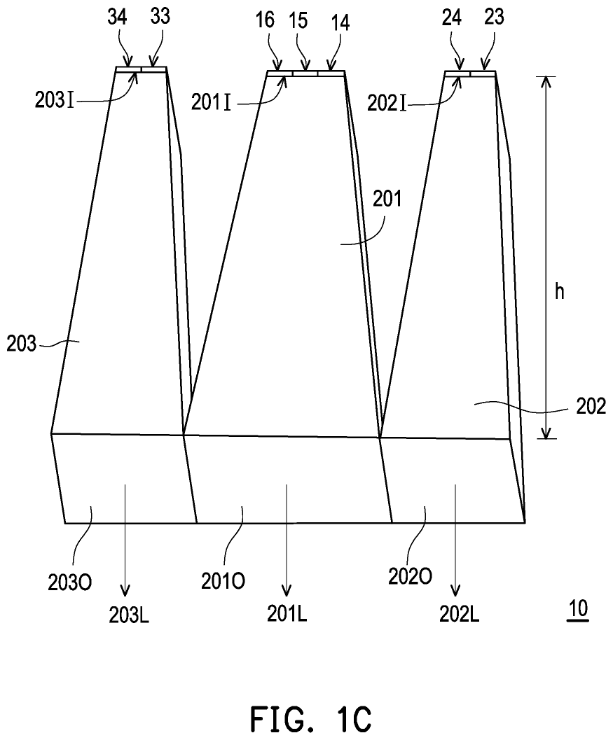

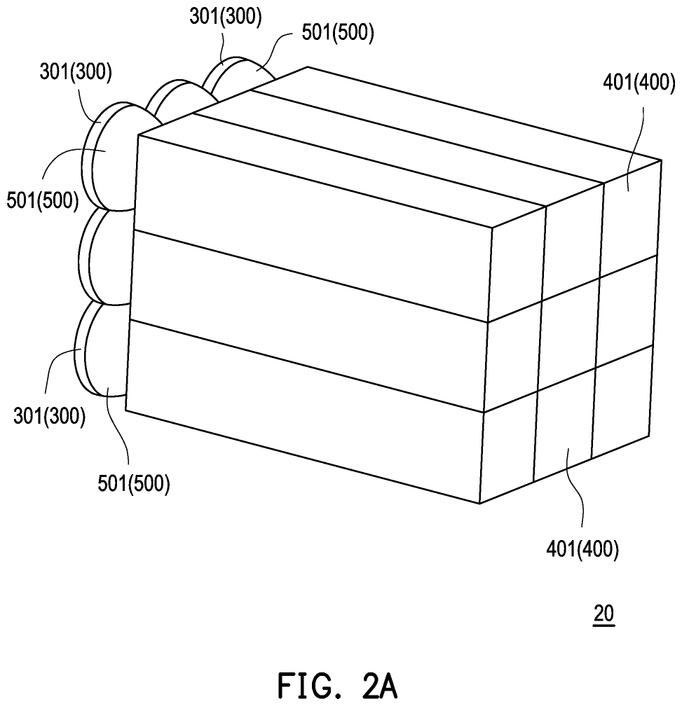

Referring to FIGS. 2A and 2B, FIG. 2A is a partial perspective view of an illuminating device according to an embodiment of the present invention, and FIG. 2B is a partial plan view of the illuminating device of FIG. 2A.

The illuminating device 20 includes a light-emitting element array 300 and a light-diffusing structure 400. The light-diffusing structure 400 includes a plurality of light-diffusing elements 401. The light-emitting element array 300 includes a plurality of discrete light-emitting areas 301. Each light-emitting area 301 includes at least one light-emitting element (not shown). The number of light-emitting elements in different light-emitting areas 301 may be the same or different.

Compared with the configuration in the previous embodiment, where the illuminating device 10 has no element disposed between each of the light-emitting elements and the corresponding light-entering surface. The illuminating device 20 further includes a lens-element array 500, which includes a plurality of lens elements 501 disposed between the light-emitting element array 300 and the light-diffusing structure 400. Light emitted by each light-emitting area 301 penetrates the corresponding lens element 501 so as to further enter the light-diffusing structure 400.

The illuminating device 20 may further include a Fresnel lens 600, which is disposed on the light-exiting side of the light-diffusing structure 400. The Fresnel lens 600, which has a short focal length, a small size, and a small thickness, may increase the illumination range of the illuminating device 20.

Compared with the configuration in the previous embodiment, where each of the light-diffusing elements 201, 202, and 203 in the illuminating device 10 has a trapezoidal-pillar shape. Each light-diffusing element 401 in the present embodiment has a rectangular-pillar shape as shown in FIG. 2A and FIG. 2B. For each light-diffusing element 401, area of the light-exiting surface is equal to area of the light-entering surface. Under this configuration, the light-diffusing elements 401 can be located closely, thereby reducing the size of the illuminating device 20.

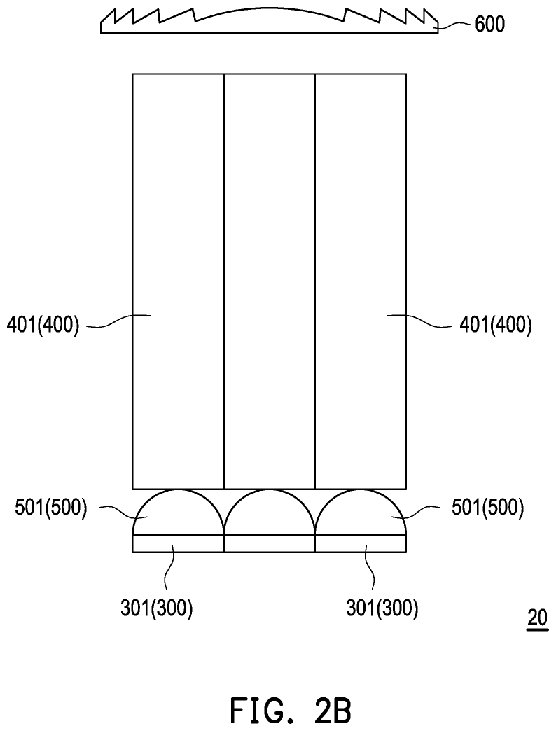

Referring to FIG. 1A and FIG. 3, FIG. 3 is a schematic diagram of a illuminating device according to an embodiment of the present invention. The illuminating device 30 includes a light-emitting element array 100, a Fresnel lens 600 and a light-diffusing structure 700. The light-diffusing structure 700 includes a plurality of light-diffusing elements 701, 702, and 703. The light-diffusing elements 701, 702, and 703 can respectively be implemented as a total reflection condensing cup, which is different from the foregoing embodiments.

Light emitted by the light-emitting element array 100 enters the light-diffusing elements 701, 702, and 703 via the light-entering surfaces thereof, gets fully homogenized in each of the light-diffusing elements 701, 702, and 703, and then forms the illumination beam 701L, 702L, 703L. In this embodiment, the Fresnel lens 600 is used to increase the illumination range.

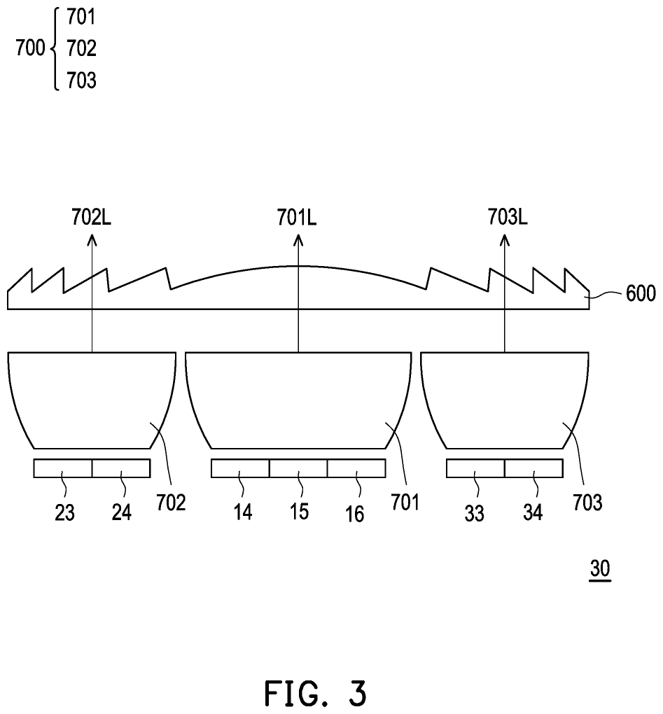

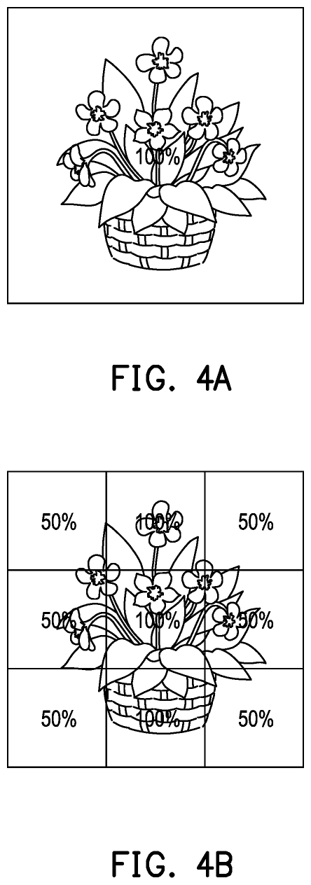

Referring to FIGS. 4A and 4B, FIG. 4A is a schematic diagram of relative illumination intensity of an illumination system according to a comparative example, and FIG. 4B is a schematic diagram of relative illumination intensity of an illumination system according to an embodiment of the present invention. The illumination system of the comparative example has a millimeter-level light-emitting diode with a single light-exiting surface of 42 mil×40 mil in size. This millimeter-level light-emitting diode is used as a light-emitting element.

In contrast, in the embodiment shown in FIG. 4B, multiple sub-millimeter light-emitting diodes are arranged as the multiple light-emitting elements of the embodiment shown in FIG. 2A. A total area of the light-exiting surfaces of the multiple sub-millimeter light-emitting diodes is 42 mil×40 mil. The corresponding light-diffusing structure may be one of the light-diffusing structures 200, 400 and 700 of the aforementioned embodiments.

Compare FIG. 4A with FIG. 4B. In the embodiment of the present invention, the multiple light-emitting elements, which are discretely arranged and whose luminous intensity can be independently controlled, rather than a single light-emitting element are used. Further, the corresponding light-diffusing elements are also used so as to provide the illumination beams, which do not completely overlap with each other and arranged in an array form. In this manner, the target region of illumination may be divided into multiple sub-regions in an array form, and the relative illumination intensity respectively provided to these sub-regions may be the same or different. In other words, the illumination intensity of the target region is not limited to a single value as shown in FIG. 4A. Specifically, as shown in FIG. 4B, the illumination intensity of the central sub-region is higher than that of other sub-regions, of which the illumination intensity may be 50% of the illumination intensity of the central sub-region. However, the present invention is not limited to thereto, and the relative illumination intensity of each sub-region may be flexibly adjusted according to the needs of design.

To sum up, in the embodiments of the present invention, multiple light-emitting elements and corresponding light-diffusing elements are utilized to provide a target region of illumination having the sub-regions in an array form. The relative illumination intensity and color temperature of different sub-regions are adjustable, and hence the effect of illumination of the whole target region is adjustable. Further, the light-diffusing elements are used to achieve homogeneousness of illumination light, and the efficiency of heat dissipation of each light-emitting elements is high.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An illuminating device, comprising:
a light-emitting element array, including a plurality of discrete light-emitting areas; and
a plurality of light-diffusing elements respectively correspond to the plurality of light-emitting areas, and each of the light-diffusing elements comprising a light-entering surface and a light-exiting surface, wherein multiple light beams emitted by the light-emitting areas respectively enter the corresponding light-diffusing element via the corresponding light-entering surface,
wherein the light beams respectively form a plurality of illumination beams after leaving the corresponding light-diffusing element via the corresponding light-exiting surface, and the plurality of illumination beams appear for illumination in an array form.

2. The illuminating device according to claim 1, wherein the plurality of illumination beams do not completely overlap with each other.

3. The illuminating device according to claim 1, wherein the plurality of light beams emitted by the plurality of light-emitting areas are white light beams.

4. The illuminating device according to claim 1, wherein a height of each light-diffusing element in a direction, along which the light beams travel, is greater than a width of the light-entering surface.

5. The illuminating device according to claim 1, wherein each of the light-emitting areas comprises a plurality of sub-millimeter light-emitting diodes arranged in an array form, so as to generate the plurality of light beams, and luminous intensity of each of the sub-millimeter light-emitting diodes is independently controlled.

6. The illuminating device according to claim 5, wherein the plurality of sub-millimeter light-emitting diodes have different color temperatures.

7. The illuminating device according to claim 5, wherein numbers of the sub-millimeter light-emitting diodes in the light-emitting areas are different.

8. The illuminating device according to claim 1, wherein each of the light-emitting areas includes a plurality of light-emitting elements arranged in an array form, so as to generate the light beams, and no element is disposed between the light-emitting elements and the corresponding light-entering surface.

9. The illuminating device according to claim 1, wherein each of the light-emitting areas includes a plurality of light-emitting elements arranged in an array form, so as to generate the light beams, and the plurality of light-emitting elements are in direct contact with the corresponding light-entering surface.

10. The illuminating device according to claim 1, wherein the plurality of light-diffusing elements are integrally formed.

11. The illuminating device according to claim 10, wherein the plurality of light-diffusing elements are manufactured in a plastic injection molding process.

12. The illuminating device according to claim 1, wherein area of the light-exiting surface of each of the light-diffusing elements is larger than area of the light-entering surface of the light-diffusing element.

13. The illuminating device according to claim 1, wherein area of the light-exiting surface of each of the light-diffusing elements is equal to area of the light-entering surface of the light-diffusing element.

14. The illuminating device according to claim 1, further comprising a lens-element array, the lens-element array includes a plurality of lens elements, the plurality of lens elements respectively correspond to the plurality of light-emitting areas, and the lens-element array is disposed between the light-emitting element array and the plurality of light-diffusing elements.

15. The illuminating device according to claim 1, further comprising a lens-element array disposed on a light-exiting side of the light-diffusing elements.

16. The illuminating device according to claim 1, further comprising a Fresnel lens disposed on a light-exiting side of the light-diffusing elements.

17. The illuminating device according to claim 1, wherein the plurality of light-diffusing elements are total reflection condensing cups.
